(19) United States
(12) Patent Application Publication
(10) Pub. No.: US 2025/0006085 A1
(43) Pub. Date: Jan. 2, 2025

(54) DISCRETE IDENTIFICATION TAG

(71) Applicant: Versaconcepts, LLC, Glendale, AZ (US)

(72) Inventor: James Umlauf, Glendale, AZ (US)

(21) Appl. No.: 18/215,626

(22) Filed: Jun. 28, 2023

(51) Int. Cl. G09F 3/08; A01K 11/00; G09F 3/02

(52) U.S. Cl. CPC G09F 3/08; A01K 11/00; G09F 3/02

(57) ABSTRACT

Systems and methods of providing a discrete identification tag, such as a discrete identification tag for identifying an animal, are disclosed. In some implementations, the discrete identification tag may be secured to a collar of an animal. The discrete identification tag includes, in some cases, a base having a face configured to receive identifying information, a back with a smooth rear surface configured to contact an animal, and a fastener configured to secure the back to the base through a pet collar.

### FIELD

The present invention relates to identification tags, and more particularly to identification tags for use in connection with another object, such as an animal collar, luggage, merchandise, or other objects or materials that can benefit from an attachable identifier.

### BACKGROUND

Traditional identification tags have many shortcomings. Many identification tags hang down from an object, which may cause annoyance due to bouncing, bobbling, swaying, or jingling. Some identification tags are bulky, having jagged edges, sharp corners, hard points, or other features that may pose a safety risk. Some identification tags include ropes, cords, chains, strings, or other loose components that could create a risk of breaking, or even of harming another object or person (e.g., through strangulation). Some identification tags are difficult to attach or remove, or they require complex custom tools to affix to or remove from an object.

As a more specific example, traditional identification tags on pet collars hang down from a portion of the collar near the front of the animal's neck. Many identification tags for pets are metal or plastic tags that attach to a collar by a loop, a chain, or another attachment mechanism that causes the tags to hang in front of the animal. These identification tags have several disadvantages, such as the potential to get caught on an object and injure the pet that is using the tag. As another example, these tags may cause noise in response to bouncing and jiggling as the pet walks or runs. Such tags also can bother or cause discomfort to pets or other animals. Many other methods of identifying an animal are inhumane, such as branding an animal, piercing the skin (e.g., ear) of an animal and inserting an identifier through the animal's flesh, or inserting a chip into the flesh (e.g., neck) of an animal. These methods can also lead to infection or pose other safety concerns.

As another specific example, luggage tags are often attached to luggage via a thin elastic band which can easily be cut, snapped, or otherwise removed maliciously or inadvertently. Moreover, the tags themselves are often made of paper or other fragile material that may easily be torn, exposed to water (whereupon identifying information may be erased due to ink bleeding), or otherwise damaged. Such problems can lead to loss or incorrect routing of luggage, potentially leading to waste and large avoidable costs.

For these reasons, there are significant limitations to the current technology in the identification tag industry. Thus, a significant need exists for a discrete, durable, and convenient identification tag that provides needed information, yet does not pose an annoyance or safety hazard. The present invention addresses and overcomes these limitations.

### BRIEF SUMMARY

Systems and methods for providing a discrete identification tag are disclosed.

According to some implementations, the discrete identification tag includes a base, a back, and a fastener. Some implementations of the base are configured to face away from a pet (e.g., by being secured to the outside surface of a collar), a piece of luggage (e.g., by being secured to a strap or handle), a piece of merchandise, or another object. Some implementations of the back are configured to face a pet (e.g., by being secured to the inside surface of a collar), be concealed on a reverse side of a produce, face the opposite direction as the base on a piece of luggage (e.g., by being disposed on an opposite side of a strap or handle), or otherwise face opposite the base. Some implementations of the fastener are configured to secure the base to the back (e.g., through a collar, a portion of a piece of luggage, a product, or any other object or material).

In some cases, the base includes a face configured to display information relating to the pet. Such face can include a badge, a plate, a tag, an engraved surface, an embossed surface, a screen, or any other component configured to display information relating to the pet. In some cases, the base is discrete. For example, some implementations of the base do not protrude past an outer surface of a collar. Indeed, in some implementations the face of the base is substantially flat and thin enough to fit into a shallow recess in a collar. In other implementations, the face of the base is configured to rest on an outer surface of a collar, but the face is thin enough to amount only to a small bump on the collar and does not jut out from the collar such that it would be likely to get caught on an object.

In some cases, the back includes a smooth rear surface to reduce friction between the back of the identification tag and the animal using the identification tag. In some cases, the back is discrete. For example, some implementations of the back do not protrude past a rear surface of a collar. Indeed, in some implementations the back of the identification tag includes a back face that is substantially flat and thin enough to fit into a shallow recess in the rear surface of a collar. In other implementations, the back face is configured to rest on a rear surface of a collar, but the back face is thin enough to amount only to a small bump on the collar and does not jut out from the interior of the collar so as to cause discomfort to the pet.

In some implementations, the fastener is configured to secure the base to the back in a permanent manner, whereas in other implementations the fastener is configured to secure the base to the back in a selective or removeable manner.

### BRIEF DESCRIPTION OF THE DRAWINGS

The objects and features of the present disclosure will become more fully apparent from the following description and appended claims, taken in conjunction with the accompanying drawings. Understanding that these drawings depict only typical embodiments of the disclosed systems and methods and are, therefore, not to be considered limiting of its scope, the systems and methods will be described and explained with additional specificity and detail through the use of the accompanying drawings in which:

FIG. 1 shows a frontal view of an identification tag in accordance with a representative embodiment of the present disclosure.

FIG. 2 shows a rear view of an identification tag in accordance with a representative embodiment of the present disclosure.

FIG. 3 shows a rear perspective view of an identification tag in accordance with a representative embodiment of the present disclosure.

FIG. 4 shows an exploded rear perspective view of an identification tag in accordance with a representative embodiment of the present disclosure.

FIGS. 5a and 5b show a rear perspective view of an identification tag in accordance with an alternative representative embodiment of the present disclosure.

### DETAILED DESCRIPTION

A description of embodiments will now be given with reference to the Figures. It is expected that the present systems and methods may take many other forms and shapes, hence the following disclosure is intended to be illustrative and not limiting, and the scope of the disclosure should be determined by reference to the appended claims.

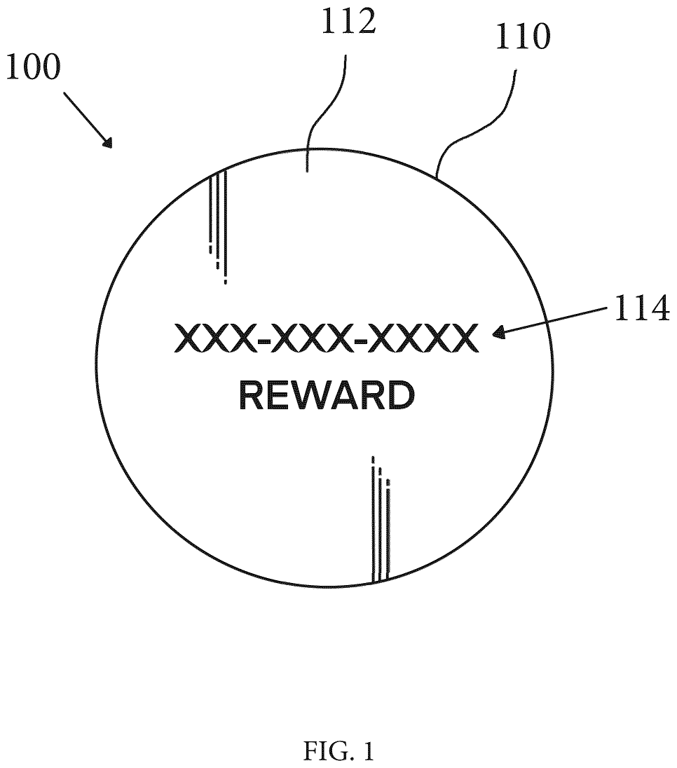

Each of FIGS. 1-5b show representative embodiments of an identification tag 100. Although the identification tag may be used to identify any suitable material or object, in some embodiments the identification tag 100 is configured to be used in connection with an animal collar for a pet or another animal (e.g., a dog, a cat, or any other animal). In some embodiments, the identification tag may be used in connection with a piece of luggage (e.g., attached to either side of a strap, a handle, a wall of the luggage, or any other suitable area). In some embodiments, the identification tag may be used in connection with a product or other merchandise, or in connection with any other object or material that could benefit from a readily attachable (and in some cases detachable and exchangeable) identification tag.

In some cases, the identification tag 100 is discrete, so as to avoid irritating an animal or person, to avoid getting caught on a piece of furniture or another object, or to avoid disrupting the aesthetic of a product or object. In some cases, the identification tag 100 is quiet (e.g., not having loose, dangling, jiggling, clicking, or other noisy components), so as to avoid causing noise that may be bothersome to a person or an animal.

Indeed, some embodiments include methods and systems for attaching identification to any consumer item, material, or other object in a low-profile, discrete manner, particularly where such object has a display surface and an accessible securement surface opposite the display surface. As a few (non-limiting examples), some suitable object with which the identification tag may be used include: animal collars, backpacks, luggage, clothing items (shoes, hats, shirts, pants, and any other clothing items), phone cases or other cases for electronic, furniture, automobile parts, food packaging, or signage. Some non-limiting examples of compatible features or surfaces of such objects or materials include tags, handles, seams, upholstery, zipper pulls, walls, sleeves, margins, straps, sheets, brims, and covers. Additionally, some embodiments of the identification tag are removable, which thereby provides an alternative for tags that are permanently sewn into a product. Accordingly, in some embodiments, the identification tag may easily be transferred to a different product (e.g., from an old backpack to new backpack, from a product purchased by a customer to a product that is still in a company's inventory, from an old animal collar to a new animal collar, from one piece of luggage to another, etc.). Accordingly, the discrete identification tag can be a useful replacement for both removable tags (e.g., dangling tags) and permanently fixed tags (e.g., tags sewn into a product).

As shown in FIG. 1, some embodiments of the identification tag 100 include a base 110. In some embodiments, the base includes a face 112 configured to face outward (e.g., away from a collar and away from an animal, so that the face 112 may be visible to an observer, away from a piece of luggage, etc.). The face 112 may be any suitable color, size, and shape, and the skilled artisan will recognize that the face 112 may be customized to include other features. Indeed, in some embodiments, the face 112 is circular, oval, triangular, square, pentagonal, hexagonal, star-shaped, octagonal, or formed in any other regular or irregular, convex or concave, polygonal or complex, 2D or 3D shape. Nevertheless, in some embodiments, the face 112 is formed in a simple 2D shape that does not jut out from the surface of the base 110. In some embodiments, the face 112 is substantially round and has no points or rough edges that could hurt an animal or damage an object. In some embodiments, the face 112 is substantially smooth.

In some embodiments, the face 112 of the base 110 includes identifying material 114. Although the identifying material may include any material configured to assist in identifying a an animal or object, in some embodiments the identifying material includes lettering, numbering, a bar code, a QR code, an RFID code, a maxicode, a data matrix, a chip, an electronic screen, a light, a speaker configured to play an identifying sound, a texture, a flavor, a scent, a color, a color combination, a fabric, a label, or another material or material combination. Nevertheless, in some embodiments the identifying information includes letter and/or numbers to display a name of a pet, a phone number, an address, a name of a person, a price, or any other human readable (or machine readable) information that can be used to identify an animal, a product, or another material or object.

In some embodiments, the base 110 includes a receptacle configured to contain an object. The base 110 may include the receptacle instead of the face 112 or in addition to the face 112. While the receptacle may be any side and shape suitable for including alongside an identification tag 100, in some cases the receptacle is configured to receive an object that includes one or more of the following: a tag, a chip, an electronic tracker, an edible material (e.g., an animal treat), a Bluetooth-compatible device, a note, or a tool. In some embodiments, the receptacle includes a cavity, and in some embodiments, the receptacle includes a cover. The cavity, in some embodiments, is shaped to correspond to a shape of an object that it is designed to receive. For example, the cavity may have a shape that substantially resembles the shape of a tracking device. Some embodiments of the cover may selectively provide access to the cavity by swinging, sliding, folding, detaching from the receptacle, deforming, or otherwise transitioning from a closed state to an open state.

Although the base 110 can have any suitable dimensions, in some cases the base is small and low-profile in order to minimize the inconvenience and chance of harming an animal. For example, in some embodiments the base 110 has a diameter (or width) of between 1 cm and 10 cm, or any subrange thereof. For example, in some cases the diameter (or width) of the base is between 1.5-3 cm. Although the base may have any suitable thickness (i.e., height), in some embodiments, the base 110 has a thickness (or height) of between 0.1 mm and 10 mm, or any subrange thereof. For example, in some cases the thickness (or height) of the base 110 is between 0.5-5 mm.

Although in some embodiments the base 110 (along with the face 112) is substantially flat (e.g., 2D, planar), in some embodiments the base 110 and/or the face 112 is curved in a manner to follow the curvature of a collar that curves around the neck (or another suitable part, such as a limb or belly) of an animal, or to follow the contours of any other object. Thus, in some embodiments, such as where the identification tag is configured to be used with a relatively large collar, the degree of curvature may be very slight (e.g., between 0 and 1 degree of curvature). On the other hand, where the identification tag is configured to be used with a relatively small collar, the degree of curvature may be greater (e.g., between 1 and 25 degrees). Overall, the degree of curvature (if any) may be anywhere between 0 and 90 degrees, or any subrange thereof. In some cases, the base 110 is malleable, such that the degree of curvature may be adjusted by hand through the application of a force to the base 110.

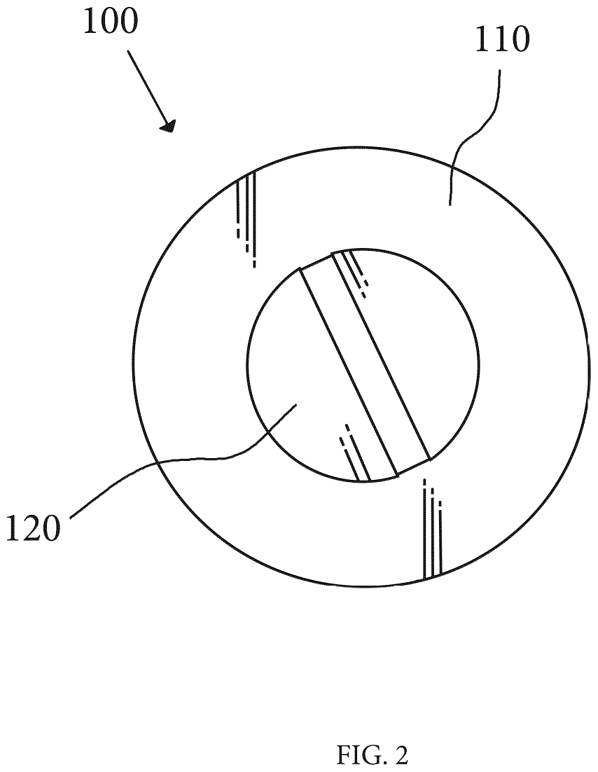

As shown in FIG. 2, some embodiments of the discrete identification tag 100 include a back 120, which may be connected (permanently or selectively) to a rear surface of the base 110. In some embodiments, the back 120 has a rear surface configured to contact or be positioned facing an animal (e.g., by being situated on the interior of an animal collar), facing the interior of a piece of luggage, facing a shelf (e.g., on a side of a product opposite from the displayed side), or otherwise facing away from an observer or concealed behind a portion of the identified material. In some embodiments, the back 120 is substantially flat, although, similar to the base 110, in some embodiments it is curved (e.g., having a degree of curvature anywhere between 0 and 90 degrees, or any subrange thereof, such as to compliment the curvature of an animal collar or another object). In some embodiments, the back 120 is substantially flat even where the base 110 is curved (or vice versa).

Moreover, while the back 120 may have any suitable shape and texture, in some cases the back is substantially round (e.g., circular, oval) so that there are no points or sharp edges which could cause discomfort to or injure an animal. In some embodiments, the back (e.g., the rear surface of the back) is smooth. Indeed, in some embodiments, the back 120 includes a cover, such as a fabric, a coating, or another cover. In some cases, the cover is configured to decrease a friction coefficient between the back 120 and another object, such as a shelf, a piece of fabric, or an animal (e.g., the animal's fur, skin, feathers, etc., thereby decreasing discomfort of the animal due to rubbing). In some cases, the cover provides padding, a softer texture, or another form of comfort to the animal. In some embodiments, the cover is selectively removeable, customizable, or interchangeable. While the cover may take any form suitable for accomplishing one or more of the objectives outlined above, in some cases the cover is formed of plastic, fabric, rubber, metal, wood, or any other material.

Although the back 120 can have any suitable dimensions, in some cases the back 120 is small and low-profile in order to minimize the inconvenience and chance of harming an animal or a person or its capacity to damage another object. For example, in some embodiments the back 120 has a diameter (or width) of between 0.5 cm and 10 cm, or any subrange thereof. For example, in some cases the diameter (or width) of the back 120 is between 0.5-2 cm. In some cases, the diameter of the back 120 is approximate equal to the diameter of the base 110, but in some embodiments the back 120 has a diameter that is between 10% and 100% of the diameter of the base 110 (or any subrange thereof). For example, in some embodiments the diameter of the back 120 is about half the diameter of the base 110. Furthermore, although the back 120 may have any suitable thickness (i.e., height), in some embodiments, the back 120 has a thickness (or height) of between 0.1 mm and 10 mm, or any subrange thereof. For example, in some cases the thickness (or height) of the back 120 is between 0.5-5 mm. In some embodiments, the thickness of the back 120 is approximately equal to the thickness of the base 110, but in some embodiments the thickness of the back 120 is between 10% and 100% of the thickness of the base 110 (or any subrange thereof).

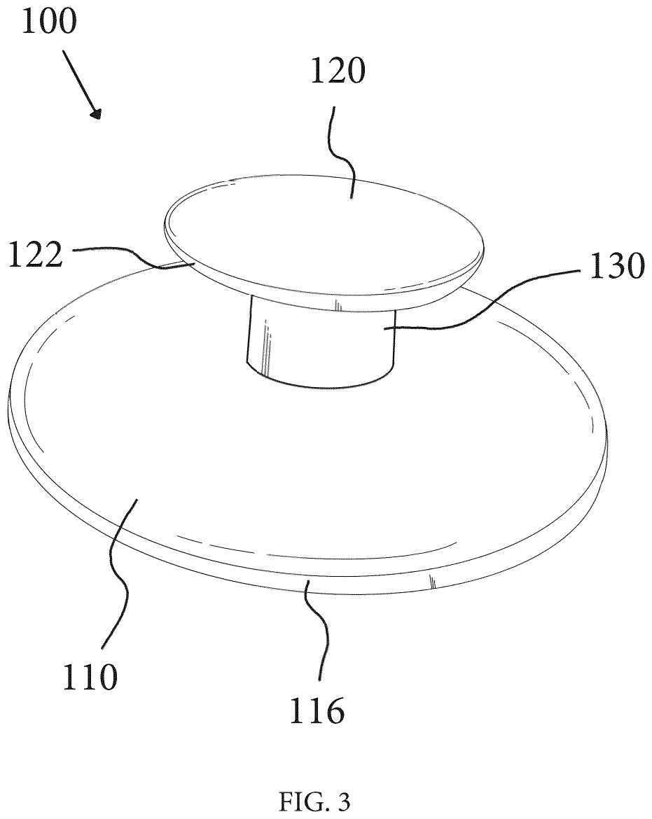

Some embodiments of the back 120 include a feature for application of a tool. For example, some embodiments include a drive (e.g., a plus, minus, star, or other indentation configured to receive a screwdriver or another tool). Some embodiments include one or more flat edges, or a general shape (e.g., hex shape) so that a wrench or a similar tool can easily find purchase around the rim (e.g., rim 122 of FIG. 3) of the back 120.

Suitable dimensions of the identification tag 100, in accordance with some embodiments, may be more easily seen in FIG. 3, which shows that the back 120 may have a rim 122 and that the base 110 may have a rim 116. The thickness of the rim 122 of the back 120 may equal the thickness of the back 120, or it may be smaller (e.g., forming a rounded, smooth edge) or larger (e.g., forming a lip extending beyond at least one of the rear surface or the inner surface of the back 120). Similarly, the thickness of the rim 116 of the base 110 may be equal to the thickness of the base 110, or it may be smaller (e.g., forming a rounded, smooth edge) or larger (e.g., forming a lip extending beyond at least one of the rear surface or the face (e.g., face 112 of FIG. 1) of the base 110).

As further shown in FIG. 3, some embodiments of the identification tag 100 include a fastener 130. In some embodiments, the fastener 130 is configured to permanently secure the base 110 to the back 120 (e.g., through an adhesive, welding, braising, rivet, permanent snap-fit, permanent interference fit, one-way lock, or any another permanent attachment), but in some embodiments, the fastener 130 is configured to removably secure the base 110 to the back 120 (e.g., so that the base 110 and the back 120 can be selectively coupled and uncoupled).

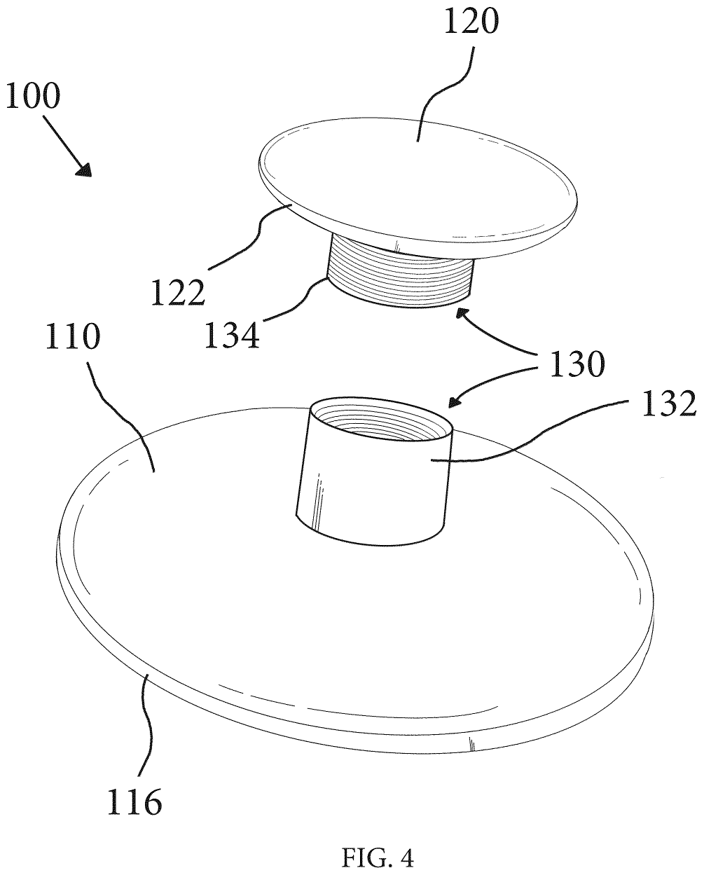

As shown in FIG. 4, the fastener 130 of the identification tag 100 may include a first connector 132 and a second connector 134. In some embodiments, the first connector 132 is secured (e.g., permanently, through welding, braising, an adhesive, or any other means) to a rear surface of the base 110. In some embodiments, the first connector 132 is secured to a center portion of the base 110 (e.g., away from the rim 116), whereas in other embodiments the first connector is secured to another portion of the base 110 (e.g., off-center, peripheral, etc.). Similarly, in some embodiments, the second connector 134 is secured (e.g., permanently, through welding, braising, an adhesive, or any other means) to a front surface of the back 120. In some embodiments, the second connector 134 is secured to a center portion of the back 120 (e.g., away from the rim 122), whereas in other embodiments the first connector is secured to another portion of the back 120 (e.g., off-center, peripheral, etc.).

In some embodiments, the fastener 130 comprises a post (e.g., the second connector 134) and a rod (e.g., the first connector 132) for receiving the post. In some embodiments, the post comprises a threading and the rod comprises a complimentary threading. In some embodiments, at least one of the threading on the post and the complimentary threading on the rod includes a threading lock (e.g., to make the attachment between the first connector 132 and the second connector 134 more secure (or even permanent or semi-permanent)).

In some embodiments, at least one of the first connector 132 and the second connector 134 is hollow, and in some embodiments, at least one of the first connector 132 and the second connector 134 is solid. In some embodiments, at least one of the first connector and the second connector has a blunt center. In some embodiments, at least one of the first connector and the second connector includes a sharpened portion configured to cut through leather, fabric, metal, wood, or another material, such as a piece of material included as part of an animal collar. As an example, in some embodiments the fastener 130 includes a sharp tip (e.g., a nail-like point at an apex of the rod) that can be pushed through an animal collar (thereby creating a hole or more easily inserting into one). As another example, in some embodiments an edge of the first connector 132 or second connector 134 (or both) is sharpened (and thereby able to cut through leather or other material by turning or spinning or pressing on the back 120 or base 110 attached to such connector). In some embodiments, the sharpened edge is notched, serrated, or otherwise configured to more efficiently cut through material. In some embodiments, when the fastener 130 is connected, the sharpened edge (or sharp tip) is entirely concealed within the fastener 130 (e.g., the sharpened edge of the second connector 134 may be entirely concealed within the first connector 132) so as to reduce the risk of irritation or injury to an animal or pet owner. Indeed, even in some embodiments not having a sharpened portion, at least one of the end of the first connector 132 and the second connector 134 (or both) is configured to be entirely concealed within the other connector or within another portion of the identification tag 100 (such as the base 110 or the back 120). In some embodiments, the sharpened portion is configured to be selectively removed (e.g., unscrewed after being used to pierce a material).

The fastener 130 is not limited to a double screw, but may include any fastener suitable for attaching the back 120 to the base 110 through an animal collar or another object or piece of material. Accordingly, in some embodiments, the fastener includes one or more of the following: a screw, a rivet, an anchor, a nail, a retaining ring, a bolt, a washer, an o-ring, a disc spring, a nut, a clip, a push-to-connect fitting, a grommet, a hook, and a peg. In some embodiments, one or more components (e.g., an o-ring or any other suitable component), increases a friction coefficient between the first connector 132 and the second connector 134 so that the first and second connectors are less likely to disengage with each other.

In some cases, the fastener 130 includes only a single connector. For example, in some embodiments the connector is attached to the base 110 and configured to piece or otherwise transverse the back 120. In some such embodiments, the connector is then smashed or flattened to provide a smooth surface. Thus, in some embodiments, no sharp points or edges that could catch on something or harm an animal or person remain after attachment.

Although the fastener 130 may have any suitable dimensions, in some cases the fastener 130 is approximately the same height as an animal collar, thus resulting in the base 110 and the back 120 being spaced apart just enough to contact the outer and inner surface of the collar (respectively). For example, in some embodiments the fastener 130 has a height of between 1 mm and 10 cm, or any subrange thereof. For example, in some cases the height of the fastener 130 is between 0.2-2 cm. In some embodiments, a diameter of the fastener 130 is between 5% and 50% (or any subrange thereof) of a diameter of the base 110, of the back 120, or of both.

In some embodiments, the fastener 130 includes an extender, which allows the first connector 132 and the second connector 134 to connect to each other with a greater distance between the back 120 and the base 110, thereby effectively increasing the height of the fastener (e.g., to accommodate a thicker collar). In some embodiments, the extender includes a male portion (e.g., to fit within a rod of at least one of the first connector 132 or second connector 134). In some embodiments, the extender includes a female portion (e.g., to receive a post of at least one of the first connector 132 or second connector 134). In some embodiments, the extender includes both a male portion and a female portion. Although the extender may be any suitable length, in some embodiments the extender is configured to increase the height of the fastener 130 by between 1% and 500% (or any subrange thereof). For example, in some embodiments the extender increases the height of the fastener 130 be between 40% and 75%.

The discrete identification tag 100 may also include any other suitable component. For example, in some embodiments, the discrete identification tag includes an electronic tracker, a chip (e.g., an electronic chip, a magnetic chip, etc.), a beeper, a light, a shocker (e.g., configured to shock an animal that passes a predefined boundary), a speaker, a GPS, or a screen. In some embodiments, the discrete identification tag 100 includes one or more processers, user interfaces, or other computing systems and components. Some embodiments are configured to link to a computer or mobile device for adjustment through an application.

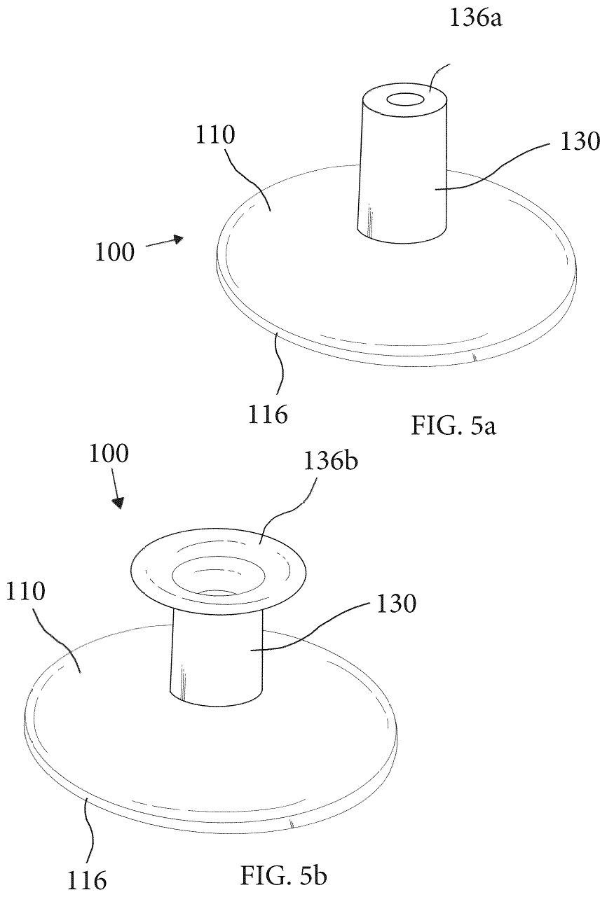

FIGS. 5a-5b show an alternative embodiment of an identification tag 100. Indeed, in some embodiments, the identification tag 100 does not have a back (e.g., back 120 of FIGS. 1-4). Instead, in some embodiments, the base 110 has a fastener 130 which has an edge 136a. In some embodiments, the edge 136a is sharp, while in others it is blunt. In some embodiments, the fastener 130 is hollow, whereas in others it is solid. The edge 136a may be configured to receive a sharp point (as a non-limiting example, the edge 136a may include threading or another type of connector). The fastener 130 may be configured to be inserted through (or to create) a hole, similar to the fastener 130 as disclosed in other embodiments. However, instead of coupling the base 110 to a back, the fastener 130 may be configured to form a back after insertion. For example, the edge 136a may be bent, smashed, hammered, rolled, expanded, roughened, or otherwise modified to become an edge 136b that is configured to prevent the identification tag from being removed. Thus, the fastener 130 may function similar to a rivet, a grommet, a one-way catch, or another feature that may allow for fixing the identification tag 100 in place after it has been applied to a material. In some embodiments, a cover (such as the cover configured to fit over the back as described above) is configured to be placed over the edge 136b after the edge 136b has been flattened and smoothened. The edge 136a may be transformed into the transformed edge 136b in any suitable manner, including but not limited to hammering the edge 136a, bending the edge 136a down, pinching or crimping the edge 136a, smashing the edge 136a, or cutting the edge 136a and moving the cut portions to different positions.

In some embodiments, the systems and methods disclosed may include an attachment kit, or providing an attachment kit, for a discrete identification tag (e.g., discrete identification tag 100 as shown in FIGS. 1-5b and described above). While the attachment kit can include any component useful for building, connecting, or attaching a discrete identification tag, some embodiments of the kit include the discrete identification tag 100 and one or more tools useful for attaching the discrete identification tag 100 to a collar or another material or object. For example, some embodiments include an attachment tool for securing the back 120 to the base 110 via the fastener 130. While the attachment tool may be any tool suited for accomplishing this, some embodiments of the attachment tool include one or more of any of the following: a screwdriver, a hex key, a hammer, pliers, a soldering set, or a wrench.

In some embodiments, the attachment kit includes a punch tool for creating a hole in a material (e.g., a pet collar, a strap, a piece of luggage, etc.), such that the hole is configured to receive the fastener 130 of the discrete identification tag 100. While the punch tool may be any tool configured to create such a hole, in some embodiments the punch tool includes one or more of any of the following: an awl, a swingline hole punch, a hollow punch, a revolving hole punch, or a drill.

In some embodiments, the attachment kit further includes one or more tools for customizing the face 112 of the identification tag 100 or the identifying material 114. While such tool may be any utilitarian or artistic tool configured to make such customizations or modifications, in some embodiments the tool includes one or more of any of the following: paint, a label maker, an engraving tool, a punch cutter, or a stamp.

In some embodiments, the attachment kit includes one or more tools for transforming the edge 136a of the fastener 130 to become an edge 136b that is configured to hold the identification tag 100 in place. For example, such tool may be a hammer, a set of pliers, a drill, a grommet tool, a pressing tool, a vice, a riveter, or another tool that may transform the edge 136a into the transformed edge 136b.

Some embodiments of the disclosed systems and methods include a method of manufacturing an identification tag 100. While the method may include any element suited to assist in the manufacture of the identification tag 100 (as shown in FIGS. 1-4 and as described above) or the attachment kit (as described above), the method may include one or more of the following steps: obtaining a base 110; obtaining a back 120; obtaining a fastener 130 having a first connector 132 and a second connector 134; attaching the first connector 132 to the base 110; attaching the second connector 134 to the back 120; and adding identifying material for identifying an animal to a face 112 of the base 110.

The portions of the method reciting obtaining a base 110, obtaining a back 120, and obtaining a fastener 130 can further include obtaining a piece of material (e.g., metal, wood, plastic, carbon fiber, stone, or any other material) and shaping it into the recited component. In some embodiments, such shaping includes cutting, bending, smoothing, sanding, polishing, injection molding, melting, burning, or any other manner of shaping a material into a desired shape.

The portions of the method reciting attaching the first connector 132 to the base 110 and the second connector 134 to the back 120 can include any means of permanently or non-permanently attaching, such as welding, braising, riveting, gluing, connecting interlocking parts, or any other suitable attaching method.

In some embodiments, the method includes attaching the base 110 to the back 120 using the connector 130. While this may include coupling the first connector 132 to the second connector 134 (in any permanent or non-permanent manner), it may also include any other method of attaching the base 110 to the back 120. For example, in some embodiments, the method includes using a single connector attached to the base to pierce or otherwise transverse the back, then hammering or otherwise deforming the connector such that it cannot be removed backward through the base, thereby connecting the base to the back. In some embodiments, the connector has a sharp tip or a sharp edge, and in some embodiments, the method includes deforming such tip or edge to provide a smooth surface.

Some embodiments of the method include carrying out one or more of the method steps without piercing, branding, injecting, or otherwise harming an animal.

The portion of the method reciting adding identifying material 114 to the face 112 may include any suitable manner for doing so, including but not limited to printing, painting, drawing, etching, engraving (mechanical engraving, laser engraving, etc.), embossing, welding, burning, and 3D printing.

In some embodiments, the disclosed systems and methods include a method of providing identifying material on an object. In some such embodiments, the object is one or more of an animal collar, a piece of luggage, a product, an article of clothing, an accessory for a digital device, a cover, a sheet of material, packaging, a tag, or a barrier, although the object may be any object having a surface with a first side and a second side, such that the surface may accommodate the identification tag in any of its embodiments.

In some embodiments, the method includes manufacturing an identification tag (e.g., in accordance with the method described above). Some embodiments of the method include boring, cutting, or otherwise creating a hole in the object (which, in some embodiments, includes using a sharpened portion of a first or a second connector of the fastener of the identification tag to make the hole). Some embodiments of the method include attaching the base of the identification tag to the back of the identification, using the fastener, with the fastener disposed within the hole, the base disposed on one side or surface of the object, and the back disposed on an opposing side or surface of the object.

As used herein, the singular forms “a”, “an”, “the” and other singular references include plural referents, and plural references include the singular, unless the context clearly dictates otherwise. For example, reference to a retractor includes reference to one or more retractors, and reference to bedcovers includes reference to one or more bedcovers. In addition, where reference is made to a list of elements (e.g., elements a, b, and c), such reference is intended to include any one of the listed elements by itself, any combination of less than all of the listed elements, and/or a combination of all of the listed elements. Moreover, the term “or” by itself is not exclusive (and therefore may be interpreted to mean “and/or”) unless the context clearly dictates otherwise. Furthermore, the terms “including”, “having”, “such as”, “for example”, “e.g.”, and any similar terms are not intended to limit the disclosure, and may be interpreted as being followed by the words “without limitation”.

In addition, as the terms “on”, “disposed on”, “attached to”, “connected to”, “coupled to”, etc. are used herein, one object (e.g., a material, element, structure, member, etc.) can be on, disposed on, attached to, connected to, or otherwise coupled to another object—regardless of whether the one object is directly on, attached, connected, or coupled to the other object, or whether there are one or more intervening objects between the one object and the other object. Also, directions (e.g., “front”, “back”, “on top of”, “below”, “above”, “top”, “bottom”, “side”, “up”, “down”, “under”, “over”, “upper”, “lower”, “lateral”, “right-side”, “left-side”, “base”, etc.), if provided, are relative and provided solely by way of example and for ease of illustration and discussion and not by way of limitation.

The described systems and methods may be embodied in other specific forms without departing from their spirit or essential characteristics. The described embodiments, examples, and illustrations are to be considered in all respects only as illustrative and not restrictive. The scope of the described systems and methods is, therefore, indicated by the appended claims rather than by the foregoing description. All changes that come within the meaning and range of equivalency of the claims are to be embraced within their scope. Moreover, any component and characteristic from any embodiments, examples, and illustrations set forth herein can be combined in any suitable manner with any other components or characteristics from one or more other embodiments, examples, and illustrations described herein.

What is claimed is:

1. A discrete identification tag comprising a base, a back, and a fastener, wherein the fastener is configured to secure the back to the base through an animal collar.

2. The discrete identification tag as recited in claim 1, wherein the base comprises a face, wherein the face is substantially flat, and wherein the face comprises identifying material configured to identify an animal.

3. The discrete identification tag as recited in claim 1, wherein the back comprises a rear surface configured to contact an animal, wherein the rear surface is substantially flat and smooth.

4. The discrete identification tag as recited in claim 3, wherein the back further comprises a drive for receiving a tool.

5. The discrete identification tag as recited in claim 1, wherein the fastener is configured to permanently secure the base to the back.

6. The discrete identification tag as recited in claim 1, wherein the fastener is configured to selectively secure the base to the back.

7. The discrete identification tag as recited in claim 1, wherein the fastener comprises a post and a rod for receiving the post.

8. The discrete identification tag as recited in claim 7, wherein the post comprises a threading and the rod comprises a complimentary threading.

9. The discrete identification tag as recited in claim 7, wherein one of the post and the rod comprises a sharp tip configured to pierce the animal collar.

10. The discrete identification tag as recited in claim 7, wherein at least one of the post and the rod comprises a sharpened edge configured to cut the animal collar.

11. The discrete identification tag as recited in claim 1, wherein the fastener comprises at least one component selected from a group consisting of the following: a screw, a rivet, an anchor, a nail, a retaining ring, a bolt, a washer, a disc spring, an o-ring, a nut, a clip, a push-to-connect fitting, a grommet, a hook, and a peg.

12. The discrete identification tag as recited in claim 1, wherein the base of the discrete identification tag comprises a receptacle configured to receive an object.

13. An attachment kit for a discrete identification tag comprising:
the discrete identification tag, which further comprises a base, a back, and a fastener, wherein the fastener is configured to secure the back to the base through a pet collar; and
a punch tool for creating a hole in a pet collar configured to receive the fastener of the discrete identification tag.

14. The attachment kit as recited in claim 13, further comprising an attachment tool for securing the back to the base via the fastener.

15. The attachment kit as recited in claim 13, wherein the base of the discrete identification tag comprises a face, wherein the face is substantially flat, and wherein the face comprises identifying material configured to identify an animal.

16. The attachment kit as recited in claim 15, wherein the back of the discrete identification tag comprises a rear surface configured to contact an animal, wherein the rear surface is substantially flat and smooth.

17. A method of manufacturing an identification tag for an animal collar, the method comprising:
obtaining a base having a substantially flat face;
obtaining a back having a substantially smooth rear surface;
obtaining a fastener having a first connector and a second connector;
permanently attaching the first connector to the base; and
permanently attaching the second connector to the back.

18. The method as recited in claim 17, wherein the method further comprises adding identifying material for identifying an animal to the face of the base.

19. The method as recited in claim 18, wherein the adding the identifying material comprises engraving.

20. The method as recited in claim 18, wherein the adding the identifying material comprises embossing.
